(19) United States
(12) Patent Application Publication
(10) Pub. No.: US 2018/0285032 A1
(43) Pub. Date: Oct. 4, 2018

(54) METHODS AND SYSTEMS FACILITATING PRINTING OF DOCUMENTS FROM AN EXTERNAL STORAGE DEVICE IN A SECURE MANNER

(71) Applicant: XEROX CORPORATION, Norwalk, CT (US)

(72) Inventor: Srinivasarao Bindana, East Godavari District (IN)

(21) Appl. No.: 15/472,336

(22) Filed: Mar. 29, 2017

(51) Int. Cl. G06F 3/12; G06F 3/06; H04N 1/00

(52) U.S. Cl. CPC G06F 3/128; G06F 3/065; G06F 3/068; H04N 2201/0094; H04N 1/00965; G06F 3/1204; G06F 3/1231; G06F 3/0619

(57) ABSTRACT

The disclosure discloses a method for facilitating printing of one or more documents from an external storage device in a secure manner. The method includes receiving the external storage device by a multi-function device. A trigger event caused by connection of the external storage device with the multi-function device is detected, the external storage device stores one or more documents for printing. At least one document for printing is selected by the user. The at least one selected document is stored in a memory of the multi-function device. A notification is displayed to the user for removing the external storage device from the multi-function device. A trigger event caused by disconnection of the external storage device is detected. A print process is initiated for the at least one selected when the external storage device is disconnected from the multi-function device. The at least one selected document is printed.

### TECHNICAL FIELD

The disclosed subject matter relates to the field of printing. More particularly, the disclosure relates to methods and systems for printing documents from an external storage device in a secure manner.

### BACKGROUND

Typically, computing devices are used in conjunction with printers or multi-function devices for easily transferring printable data from an internal memory of the computing devices to the printers. The computing devices further facilitate printing of data stored in external storage devices, such as USB drives, memory cards, disk drives, etc. These days printers support direct access to such external storage devices, such as USB drives for printing without any intervention of external computing devices. USB drives such as portable flash drives and dongles include an integrated external peripheral interface port connector and store and transfer data between computing devices.

USB drives have been proved revolutionary for the technical advancement of computing devices, especially for printers. Unfortunately, there are certain security flaws with the USB drives, which are yet to be worked upon. For example, USB drives that are left attached to a printing, or can be easily broken if users bump into them while in use and this may sometimes interrupt an ongoing print process. It is observed that users generally forget to take back their plugged-in USB drives and walk away with printouts only. In such cases, the USB drives can be easily stolen due to their removability and due to their small size, which may result in data loss. This can ultimately impact the business and thus, it becomes very important to maintain security of such devices as well as data stored therein. Therefore, there is a need for methods and systems for facilitating printing of documents from an external storage device in a secure manner.

### SUMMARY

A multi-function device facilitating printing of one or more documents from an external storage device in a secure manner is disclosed. The multi-function device includes a peripheral port for communicating with the external storage device. The multi-function device includes a memory for storing computer readable program code. The multi-function device further includes a controller for executing the computer readable program code to control the multi-function device, the computer readable program code being configured to cause the multi-function device to execute a process for: detecting a first trigger event caused by connection of the external storage device with the peripheral port, wherein the external storage device stores one or more documents for printing; receiving a selection of at least one document by the user for printing, via a user interface of the multi-function device; copying the at least one selected document from the external storage device and storing the at least one selected document in the memory of the multi-function device; before printing, displaying a notification to the user for removing the external storage device from the peripheral port; detecting a second trigger event caused by disconnection of the external storage device from the peripheral port; initiating a print process for the at least one document only when the external storage device is disconnected from the peripheral port; and printing the at least one selected document.

A printer including a peripheral port, a user interface, a memory and a controller. The peripheral port is configured to: receive an external storage device having one or more documents for printing. The user interface is configured to: receive at least one document for printing; and receive one or more print settings for printing the at least one document. The memory is configured to store the at least one document for printing. The controller is configured to: before printing, display an alert message to the user for removing the external storage device; initiate the print process for the at least one document when the external storage device is removed from the peripheral port; and print the at least one document; and automatically delete the at least one document when printing of the at least one document is complete.

A method for facilitating printing of one or more documents from an external storage device in a secure manner is disclosed. The method includes receiving the external storage device by a multi-function device. A trigger event caused by connection of the external storage device with the multi-function device is detected, wherein the external storage device stores one or more documents for printing. A selection of at least one document by the user for printing is received, via a user interface of the multi-function device. The at least one selected document is copied from the external storage device and the at least one selected document is stored in a memory of the multi-function device. A notification is displayed to the user for removing the external storage device from the multi-function device. Then, a trigger event caused by disconnection of the external storage device is detected. A print process is initiated for the at least one selected when the external storage device is disconnected from the multi-function device. The at least one selected document is printed.

### BRIEF DESCRIPTION OF THE DRAWINGS

FIG. 1 illustrates an exemplary environment in which various embodiments of the disclosure may be practiced.

FIG. 2 shows exemplary components of a multi-function device, according to an embodiment of the disclosure.

FIG. 3 shows an exemplary notification message as generated for removing an external storage device.

FIG. 4 is a method flowchart for facilitating printing of documents from an external removable storage device in a secure manner.

### DETAILED DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Definitions

Definitions of one or more terms that will be used in this disclosure are described below without limitations. For a person skilled in the art, it is understood that the definitions are provided just for the sake of clarity, and are intended to include more examples than just provided below.

The term “multi-function device” is a single device or a combination of multiple devices that are configured to perform more than one function such as, but not limited to, scanning, printing, imaging, and so forth. The multi-function device may include software, hardware, firmware, and combination thereof. The multi-function device may interchangeably be used with the phrase “printer” or “printer device.” In the context of the current disclosure, the multi-function device is configured to generate an alert message or notification for a user to securely remove an external storage device before initiating a print process. Further, the multi-function device include various components such as a peripheral port, a user interface, a controller/processor, a memory, or any additional components needed for implementing the current disclosure.

The term “document” refers to a soft copy of a pre-defined format such as PDF, word, PPT, etc.

The term “external removable storage device” includes any portable storage device having a memory and a physical or wireless communication bus including, but not limited to, USB memory drives, memory cards, hard drives, etc. The external removable storage device includes one or more documents for printing. The phrase may also be interchangbly be used with “external storage device,” “removable storage device,” or the like.

The term “notification” includes a pop-up message displayed to the user via a user interface of the multi-function device. The notification relates to removal of the external removable storage device.

An “event” refers to a trigger generated when the external removable storage device is connected to the multi-function device and a second event/trigger is generated when the external removable storage device is disconnected from the multi-function device.

### Overview

It is common that an external removable storage device such as a pen drive is ejected once print job is done. But there is a high possibility that users forget to collect the pen drive from the multi-function device and it can lead to loss of confidential data. In order to secure the data stored with such devices as well as to secure these devices, the current disclosure provides methods and systems. The methods and system facilitate printing of one or documents from the external storage devices in a secure manner.

### Exemplary Embodiments

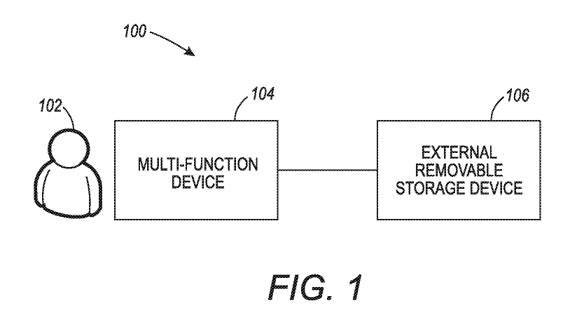

FIG. 1 illustrates an exemplary environment 100 in which various embodiments of the disclosure can be practiced. The environment 100 includes a user 102, a multi-function device 104 and an external removable storage device 106.

Typically, the user 102 uses the multi-function device 104 for his day-to-day tasks such as printing, scanning, imaging and so forth. The multi-function device 104 includes various components such as a peripheral port, a controller, a memory, and a user interface. In some cases, the multi-function device 104 may be configured to authenticate the user 102 for using the multi-function device 104 or corresponding functionalities of scanning, printing, copying, and so forth. The user 102 may be authenticated using user name & password, biometric information, and so on.

As shown, the external removable storage device 106 is used by the user 102 to store one or more documents or data. The data may be confidential, private, personal and so forth. Various examples of the external removable storage device 106 include but not limited to, USB flash drives, memory cards, memory sticks, USB hard disks, and so on. Other than this, the disclosure may be implemented for any kind of storage device or authentication device associated with the multi-function device 104.

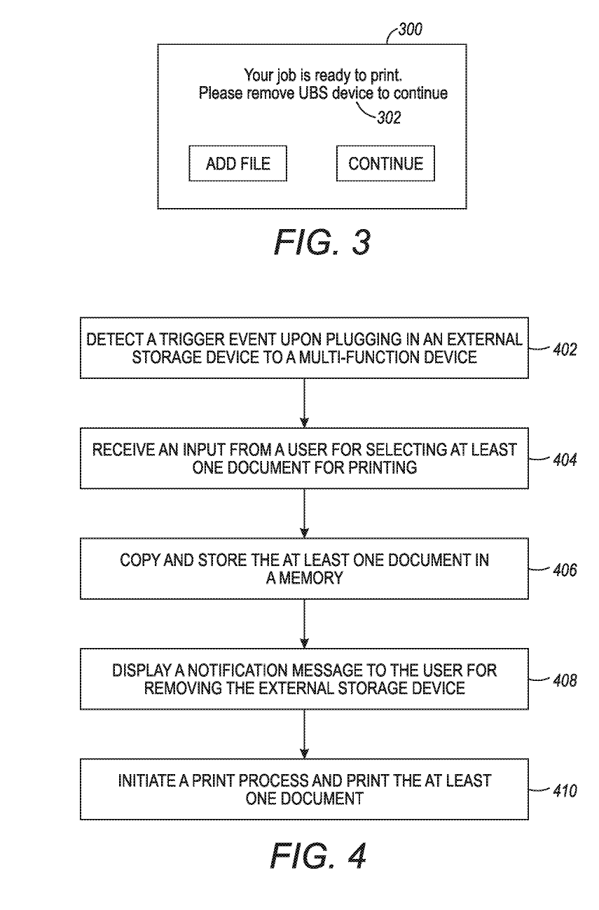

Typically, the user 102 connects or plugs the external removable storage device 106 to the multi-function device 104. The multi-function device 104 detects the external removable storage device 106 and receives an input from the user. The input includes a document, which the user wishes to print. Based on the input, the multi-function device 104 prints the selected document. Here, the user collects the printed document and may forget the external removable storage device 106 plugged within the multi-function device 104. In the context of the current disclosure, before printing the selected document, the multi-function device 104 generates an alert for the user 102 to remove the external removable storage device 106 and collects the external removable storage device 106. One such exemplary snapshot 300 is shown in FIG. 3. The snapshot 300 shows a notification or message 302 for the user 102. Based on the alert, the user 102 removes the external removable storage device 106. The multi-function device 102 then initiates a printing process and prints the document. Here, the alert acts as a reminder for the user 102 to collect the external removable storage device 106 so that the external removable storage device 106 as well as documents within the external removable storage device 106 stay secure. This prevents leakage of the confidential document stored in the external removable storage device 106 as well as loss of the external removable storage device 106.

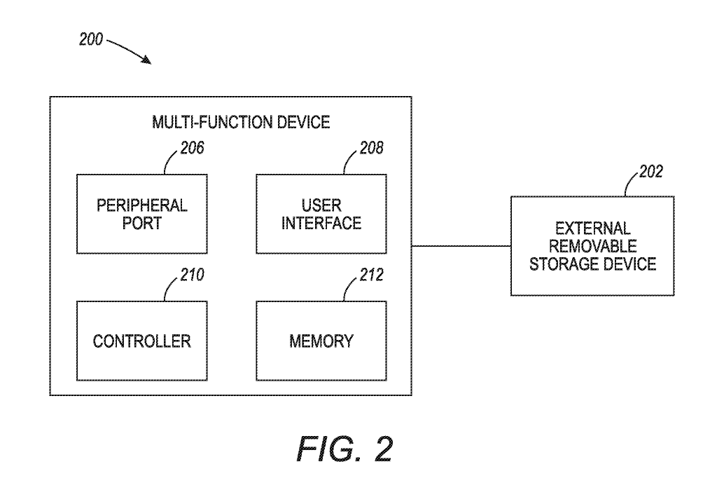

FIG. 2 illustrates an exemplary block diagram of a multi-function device such as a printer 200 used for printing a digital file. The printer 200 facilitates printing of one or more documents from an external removable storage device 202 coupled to the printer 200. The printer 200 includes a peripheral port 206, a user interface 208, a controller 210 and a memory 212. The printer 200 may include a temporary memory although not shown).

As known, the external removable storage device 202 includes a connector, a memory and a controller (although not shown). The connector is in connection with the controller and the memory to create an electrical connection. The controller facilitates the data communication between the printer 200 and the external removable storage device 202. The printer 200 provides inbuilt libraries to be installed before using the external removable storage device 202. Other structural and operational details of the external removable storage device 202 remain the same as known in the art or later developed technology and thus, are not necessary for the implementation of the disclosure.

The peripheral port 206 receives the external removable storage device 202 such a pen drive and establishes a communication with the pen drive. The peripheral port 206 is the port that allows coupling of the printer 200 with the external storage device 202, facilitating communication with the external storage device 202. The memory 212 stores profiles of the user, user authentication data, credentials of the user or any other details. The memory 212 stores computer readable program code that is executed by the controller 210 to control the printer 200. The computer program with computer readable program code can be executed in many exemplary ways, such as an application that is resident in the memory 212 of the printer 200 or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory 212 on the printer 200 or from a hosted server, such as BASIC, COBOL, C, C++, Java, Pascal, or scripting languages such as JavaScript, Python, Ruby, PHP, Perl or other sufficient programming languages. The disclosed computer programs can be implemented on non-transitory computer readable carriers adapted to allow the processor to execute the program code. In the context of the current disclosure, the computer readable program code is configured to cause the printer 200 to execute a process of printing one or more documents from the external removable storage device 202 such as pen drive 202.

The peripheral port 206 receives the pen drive 202 as plugged-in by the user. Upon plugging-in, the controller 210 detects a triggered event, i.e., connection of the pen drive 202 with the printer 200. The controller 210 automatically access the pen drive 202 and opens folders or files within the pen drive 202. The controller 210 then requests the user to provide an input via the user interface 208, i.e., one or more documents to be printed. Thereafter, the controller 210 requests for additional inputs from the user, i.e., number of prints, double sided or single sided, or the like. The controller 210 then copies and saves the selected documents in the memory 212 or local memory of the printer 200. The controller 210 generates a notification for the user to unplug the pen drive 202 from the printer 200. The notification is generated via the user interface 208 of the printer 200 so that the user does not forget collecting the pen drive 202 that contains confidential and/or personal data. The user then unplugs the pen drive 202 from the printer 200.

The controller 210 detects a second triggered event i.e., disconnection of the pen drive 202 from the printer 200. The dis-connection includes physical removal of the pen drive 202 from the printer 200.

In some cases, the printer 200 waits for a pre-defined time interval to check whether the pen drive 202 is removed from the printer 200. In case the pen drive 202 is not disconnected by the user, the controller 210 generates an alert for an admin user. The alert may be generated for the admin user via an email notification, a text message, SMS or the like for any assistance to look into the matter or to assist the user for using the printer 200. This configuration ensures that the user never forgets to recover the pen drive 202 from the printer 200 as print process is not initiated unless the user recovers the pen drive 202. This protects loss of flash drives, restricts data theft probabilities, and benefits in circumstances where the pen drive 202 fails, malfunctions, or gets broken while in use. This ultimately benefits the security policies of organizations.

Once removed, the controller 210 initiates a print process and prints the selected document based on the properties as provided by the user. Thereafter, the controller 210 automatically deletes the document saved for printing. Alternatively, the controller 210 may seek confirmation from the user to delete the document saved for printing.

In some cases, the pen drive 202 may include pre-set folder where the user can place the documents for printing along with print settings such as number of copies, color print or mono-color print, page numbers from the file for printing, etc.

In one implementation, a server (although not shown) controls all the functionalities related to the printer 200 as above. In the context of the current disclosure, the server is configured to generate a notification for the user for removing the external removable storage device. The server further instructs the printer 200 to print the selected documents only when the external storage device is removed by the user.

FIG. 4 illustrates a flow diagram of a method for printing one or more documents from an external removable storage device. The method is explained with respect to a device such as a printer, a multi-function device, etc.; however, inputs from a user are also taken.

Initially, the method begins with when a user wishes to print one or more documents, which are stored in an external storage device. The external storage device may include one or more documents for printing in a specific folder or sub-folders. The external storage device may also include other data or documents of the user that may not be for printing. The documents may be in any suitable format such as PDF, doc, ppt, docs, or any other suitable formats as known in the art or developed later. For example, the documents may be forms, books, identity proofs, address proof, photos or the like. Here, the user plugs-in the external removable device to the multi-function device.

Then at 402, a trigger event is detecting upon plugging-in the external storage device to the multi-function device. The external storage device is detected by the multi-function device and a connection is established with the external storage device to access data stored therein. Once established, automatically accessing one or more folders as stored in the external removable storage device. In some embodiments, a pre-designated folder (i.e., a folder with pre-designated name) may be searched for by the multi-function device to access data stored therein. The pre-designated folder may include one or more documents for printing and print instructions as saved by the user.

Thereafter, at 404, an input from the user is received for selecting at least one document for printing, via a user interface of the device. At 406, based on the input from the user, the at least one document is copied and stored in a memory of the device. The at least one document may be stored in a temporary memory of the device. Once successfully copied, at 408, a notification message is displayed to the user for removing the external storage device from the multi-function device. The notification message is displayed to the user at the multi-function device.

Then, it is checked/detected whether the external removable storage device is removed physically from multi-function device. Here, the user removes the external removable storage device from the multi-function device. Based on that, a print process is initiated at 410, by the multi-function device and finally the at least one document is printed. The at least one document is printed only when the external storage device is removed from the multi-function device. The at least one document is printed using default print settings. While, the at least one document may be printed based on settings as received from the user. The settings may be provided via a user interface of the multi-function device.

Once the print job is completed, the at least one document is automatically deleted from the memory. The at least one document may also be deleted manually by the user. In this manner, the security of confidential documents, personal documents is maintained by alerting the user to collect the external storage removable device from the multi-function device.

The disclosure discloses methods and systems facilitating printing of one or more documents from external removable devices in a secure manner. Specifically, the disclosure provides a notification message to a user for removing the external removable storage device so that the user never forgets the external removable storage device at the multi-function device. In addition, the disclosure allows the user to submit print jobs in one go and further allows the user to collect the print jobs later.

It will be appreciated by a person skilled in the art that the exemplary embodiments are not restricted to any particular format print settings on a file or on a folder. The embodiments are intended to include or otherwise cover all permutations and combinations of print settings stored inside files/folders. Further, implementation of the embodiments may not require any hardware specific changes in printing devices, because various printing device software modules are sufficient in instructing printers according to the methods disclosed herein. It can therefore be beneficial to allow a user to use his/her portable memory devices for taking printouts with desired print settings, without much interaction with user interfaces of printers, and with minimal or no wait time.

For a person skilled in the art, it is understood that the use of phrase(s) “is,” “are,” “may,” “can,” “could,” “will,” “should” or the like is for understanding various embodiments of the present disclosure and the phrases do not limit the disclosure or its implementation in any manner.

The order in which the method is described is not intended to be construed as a limitation and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above described system and/or the apparatus and/or any electronic device (not shown).

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “generating,” or “monitoring,” or “displaying,” or “tracking,” or “identifying,” “or receiving,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A multi-function device facilitating printing of one or more documents from an external storage device in a secure manner, the multi-function device comprising:
a peripheral port for communicating with the external storage device;
a memory for storing computer readable program code; and
a controller for executing the computer readable program code to control the multi-function device, the computer readable program code being configured to cause the multi-function device to execute a process for:
detecting a first trigger event caused by connection of the external storage device with the peripheral port, wherein the external storage device stores one or more documents for printing;
receiving, from a user, a selection of at least one document for printing, via a user interface of the multi-function device;
copying the at least one selected document from the external storage device, and storing the at least one selected document in the memory of the multi-function device;
before printing, displaying a notification to the user for removing the external storage device from the peripheral port;
checking after a particular time interval, whether the external storage device has been removed from the peripheral port;
in response to determining that the external storage device has not been removed from the peripheral port, generating an alert for another user to assist the user;
detecting a second trigger event caused by removal of the external storage device from the peripheral port;
initiating a print process for the at least one selected document, in response to detecting the second trigger event; and
printing the at least one selected document.

2. The multi-function device of claim 1, wherein the controller is configured for automatically deleting the at least one selected document, from the memory of the multi-function device.

3. The multi-function device of claim 1, wherein the at least one selected document is printed using default print settings.

4. The multi-function device of claim 1, wherein the at least one selected document is printed based on settings as received from the user.

5. The multi-function device of claim 1, wherein the external storage device is one of a flash drive, a memory card, and a hard disk.

6. The multi-function device of claim 1, wherein the at least one selected document is copied in a temporary memory of the multi-function device.

7. The multi-function device of claim 1, wherein the controller is configured for displaying a notification to the user for deleting the at least one selected document.

8. The multi-function device of claim 1, wherein the external storage device is removable.

9. A printer, comprising:
a peripheral port configured to:
receive an external storage device having one or more documents for printing;
a user interface configured to:
receive, from a user, selection of at least one document for printing; and
receive one or more print settings for printing the at least one document;
a memory configured to store the at least one document for printing; and
a controller configured to:
before printing, display an alert message to the user for removing the external storage device from the peripheral port;
check after a particular time interval, whether the external storage device has been removed from the peripheral port;
in response to a determination that the external storage device has not been removed from the peripheral port, generate another alert message for another user to assist the user;
initiate the print process for the at least one document when the external storage device is removed from the peripheral port;
print the at least one document; and
automatically delete the at least one document after printing of the at least one document is complete.

10. The printer of claim 9, wherein the another alert message is one of: an email notification, a text message, or an SMS.

11. A method for facilitating printing of one or more documents from an external storage device in a secure manner, the method comprising:
receiving the external storage device by a multi-function device;
detecting a trigger event caused by connection of the external storage device with the multi-function device, wherein the external storage device stores one or more documents for printing;
receiving, from a user, a selection of at least one document for printing, via a user interface of the multi-function device;
copying the at least one selected document from the external storage device, and storing the at least one selected document in a memory of the multi-function device;
before printing, displaying a notification to the user for removing the external storage device from the multi-function device;
checking after a particular time interval, whether the external storage device has been removed from the multi-function device;
in response to determining that the external storage device has not been removed from the multi-function device, generating an alert for another user to assist the user;
detecting another trigger event caused by removal of the external storage device;
initiating a print process for the at least one selected document, in response to detecting the another trigger event; and
printing the at least one selected document.

12. The method of claim 11, further comprising automatically deleting the at least one selected document, from the memory of the multi-function device.

13. The method of claim 11, further comprising deleting the at least one selected document by the user.

14. The method of claim 11, wherein the at least one selected document is printed using default print settings.

15. The method of claim 11, wherein the at least one selected document is printed based on settings as stored in the external storage device.

16. The method of claim 11, wherein the external storage device is one of a flash drive, a memory card, and a hard disk.

17. The method of claim 11, wherein the at least one selected document is copied in a temporary memory of the multi-function device.

18. The method of claim 11, further comprising displaying another notification to the user for deleting the at least one selected document.

19. The method of claim 11, wherein generating the alert for the another user comprises generating one of an email notification, a text message, or an SMS.

20. The method of claim 11, wherein the multi-function device is a printer.
